(19) United States
(12) Patent Application Publication
(10) Pub. No.: US 2022/0179090 A1
(43) Pub. Date: Jun. 9, 2022

(54) SYSTEMS AND METHODS FOR DETECTING AND ADDRESSING A POTENTIAL DANGER

(71) Applicant: Pony Al Inc., Grand Cayman (KY)

(72) Inventors: Francisco Javier Rovira de la Torre, Fremont, CA (US); Qi Wang, Fremont, CA (US)

(21) Appl. No.: 17/117,085

(22) Filed: Dec. 9, 2020

(51) Int. Cl. G01S 17/931; G01S 17/89; G06K 9/00; G06K 9/62; A62C 27/00; G06N 20/00

(52) U.S. Cl. CPC G01S 17/931; G01S 17/89; G06K 9/00825; G06N 20/00; G06K 9/6256; A62C 27/00; G06K 9/00744

(57) ABSTRACT

Systems, methods, and computer readable storage media are provided for detecting and addressing a potential danger. The detecting and addressing a potential danger further includes acquiring data, using one or more sensors on a vehicle, at a location; identifying, using the one or more processors, characteristics at the location based on the acquired data; determining, based on the identified characteristics, a level of danger at the location; and in response to determining that the level of danger satisfies a threshold level, issuing an alert.

### FIELD

This disclosure relates to systems and methods of detecting and addressing a potential danger that have limited use as surveillance tools.

### BACKGROUND

In a world where cameras are everywhere, an ability to find a missing individual while maintaining privacy of other individuals is a worthy goal that has thus far eluded us. When a person is reported missing, finding the person quickly is often of the utmost importance. A missing person may be a lost child, adult, criminal, or a person of interest. Cameras carried by most individuals can be leveraged to scan an environment for the missing person. In particular, vehicles with cameras can scan a large area quickly. Therefore vehicles with cameras can be leveraged to find missing persons. However, leveraging vehicles with cameras to find missing persons can possibly be abused to watch and control general population. Accordingly, there is a need to limit vehicles with cameras to track ordinary individuals that are not missing persons. Additionally, a need to monitor environmental, natural, and traffic conditions also needs to be addressed.

### SUMMARY

In some embodiments, a method of detecting and addressing a potential danger is implemented by one or more processors. The method may include, acquiring data, using one or more sensors on a vehicle, at a location; identifying, using the one or more processors, characteristics at the location based on the acquired data; determining, based on the identified characteristics, a level of danger at the location; and in response to determining that the level of danger satisfies a threshold level, issuing an alert.

In some embodiments, the one or more sensors comprise a particulate sensor, and the identifying the characteristics comprises determining a particulate concentration, the determining the particulate concentration comprising: channeling air through a laser beam in a channel of the particulate sensor; detecting, by a photodetector of the particulate sensor, an amount and pattern of light scattered by the laser beam; and determining the particulate concentration based on the amount and the pattern of light scattered by the laser beam.

In some embodiments, the one or more sensors comprise a LiDAR and a camera; and the identifying the characteristics comprises determining an existence, a type, and a severity of a disaster.

In some embodiments, the determining the existence, the type, and the severity of the disaster comprises: acquiring sequential video frames of the disaster; identifying, using semantic segmentation and instance segmentation, features in the sequential video frames; detecting changes in the features across the sequential video frames; and determining the existence, the type, and the severity of the disaster based on the detected changes.

In some embodiments, the determining the existence, the type, and the severity of the disaster is implemented using a trained machine learning model, the training of the machine learning model comprising training using a first set of training data based on an analysis of a single frame and a second set of training data based on an analysis across frames.

In some embodiments, the method further comprises, in response to detecting that the type of the disaster is a fire, activating a pressurized hose of the vehicle to spray water or a flame retardant fluid over the disaster.

In some embodiments, the method further comprises, acquiring additional video frames of the disaster while spraying the water or the flame retardant fluid over the disaster; determining, from the additional acquired video frames, whether the disaster is being mitigated; in response to determining that the disaster is being mitigated, continuing to spray the water or the flame retardant fluid over the disaster; and in response to determining that the disaster is not being mitigated, terminating the spraying of the water or the flame retardant fluid over the disaster and issuing an alert.

In some embodiments, the detecting the changes in the features comprises detecting changes in a concentration of people and changes in a structure at the location.

In some embodiments, the identifying, with one or more sensors on a vehicle, characteristics at a location, comprises identifying a level of traffic at the location.

In some embodiments, in response to detecting that the level of traffic exceeds a traffic threshold, blockading additional vehicles from entering the location or directing the additional vehicles through an alternative route.

Some embodiments include a system on a vehicle, comprising: one or more sensors configured to acquiring data at a location; one or more processors; and memory storing instructions that, when executed by the one or more processors, cause the system to: identify characteristics, based on the acquired data, at the location; determine, based on the identified characteristics, a level of danger at the location; and in response to determining that the level of danger satisfies a threshold level, issuing an alert.

In some embodiments, the one or more sensors comprise a particulate sensor. The particulate sensor comprises: a channel through which air is funneled through; a photodiode configured to emit a laser beam; a photodetector configured to detect an amount and a pattern of scattering from the laser beam and determine a particulate concentration of the air based on the amount and the pattern of light scattered by the laser beam. The particulate sensor further comprises a fan, wherein a speed of the fan is adjusted based on the determined particulate concentration of the air.

In some embodiments, the one or more sensors comprise a LiDAR and a camera; and the identifying the characteristics comprises determining an existence, a type, and a severity of a disaster.

In some embodiments, the determining the existence, the type, and the severity of the disaster comprises: acquiring sequential video frames of the disaster; identifying, using semantic segmentation and instance segmentation, features in the sequential video frames; detecting changes in the features across the sequential video frames; and determining the existence, the type, and the severity of the disaster based on the detected changes.

In some embodiments, the determining the existence, the type, and the severity of the disaster is implemented using a trained machine learning model, the training of the machine learning model comprising training using a first set of training data based on an analysis of a single frame and a second set of training data based on an analysis across frames.

In some embodiments, the instructions further cause the system to perform: in response to detecting that the type of the disaster is a fire, activating a pressurized hose of the vehicle to spray water or a flame retardant fluid over the disaster.

In some embodiments, the instructions further cause the system to perform: acquiring additional video frames of the disaster while spraying the water or the flame retardant fluid over the disaster; determining, from the additional acquired video frames, whether the disaster is being mitigated; in response to determining that the disaster is being mitigated, continuing to spray the water or the flame retardant fluid over the disaster; and in response to determining that the disaster is not being mitigated, terminating the spraying of the water or the flame retardant fluid over the disaster and issuing an alert.

In some embodiments, the detecting the changes in the features comprises detecting changes in a concentration of people and changes in a structure at the location.

In some embodiments, the identifying the characteristics at the location comprises identifying a level of traffic at the location.

In some embodiments, the instructions further cause the system to perform: in response to detecting that the level of traffic exceeds a traffic threshold, blockading additional vehicles from entering the location or directing the additional vehicles through an alternative route.

Another embodiment of the present disclosure includes methods for finding an individual with a vehicle. In an exemplary embodiment, the method includes scanning, with one or more sensors, individuals at a location, comparing data of scanned individuals with data regarding one or more missing persons, and determining that a matched individual that was scanned matches the data regarding one or more missing persons. The method further includes generating a report that includes an identity of the matched individual and the location of the matched individual responsive to determining that the matched individual matches the data regarding the one or more missing persons and transmitting the generated report to a third party. The generated report further includes the time when the image of the matched individual was scanned. The generated report further includes the speed the matched individual is traveling. The generated report further includes a predicted area to which the matched individual may travel. The generated report further includes an image of the matched individual. The method further includes receiving an authorization signal prior to scanning the individuals and receiving data regarding one or more missing persons prior to scanning the individuals. The method further includes generating an image of the matched individual and deleting the data of scanned individuals not matched to the one or more missing persons. The method further includes receiving a consent signal prior to scanning the individuals. The method further includes deactivating the sensors, on the detecting vehicle, a period of time after receiving the authorization signal.

In an exemplary embodiment, a detecting system includes one or more sensors, on a vehicle, that scan individuals, a computer on the vehicle that compares scanned individuals to data on one or more missing persons where the computer is configured to determine that the individuals that were scanned match the data regarding one or more missing persons. The computer may be further configured to generate a report that includes an identity of a matched individual and the location of the matched individual responsive to a determination that the matched individual matched the data regarding the one or more missing persons. The report may contain the time when the image of the matched individual was scanned and the speed the matched individual is traveling. The computer may be further configured to transmit the generated report to a third party. The report may further include an image of the matched individual. The report may further include the speed at which the matched individual is traveling and the time that the image of the matched individual was taken. The report may further include a predictive circle where the missing person may travel. The detecting system further includes an antenna that receives data regarding the one or more individuals. The computer may be further configured to delete the data of scanned individuals not identified as the one or more missing individuals. The computer may be further configured to receive an authorization signal where the sensors scan individuals responsive to receiving the authorization signal. The authorization signal may be received from a third party where the sensors deactivate a period of time after receiving the authorization signal where the period of time is determined by the authorization signal. The computer is further configured to receive a consent signal where the sensors scan individuals responsive to receiving both the authorization signal and the consent signal.

Another general aspect is a computer readable storage medium in a vehicle having data stored therein representing a software executable by a computer, the software comprising instructions that, when executed, cause the vehicle to perform the actions of receiving data of a missing person from a third party and scanning individuals using one or more sensors. The software instructions cause the computer to perform the action of matching the data of the missing person with a scanned individual and generating a report about the scanned individual. The software instructions cause the computer to further perform censoring the individuals in the image who do not match the data of the missing person where the report includes a location and an image of the scanned individual and the report further includes a color of clothing, belongings, and surroundings of the scanned individual. The software instructions cause the computer to further perform deleting images of individuals that do not match the data of the missing person. The software instructions cause the computer to further perform determining a predictive area of where the scanned individual is traveling and transmitting the report to the third party where the report includes the direction the scanned individual is traveling and the predictive area. The software instructions cause the computer to further perform receiving an authorization signal and a consent signal prior to scanning individuals.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the present disclosure are utilized, and the accompanying drawings of which:

FIG. 1 is a schematic illustrating the components of the detecting system that may be used.

FIG. 2 is a flow diagram of a process of detecting missing persons with a vehicle.

FIG. 3 is a flow diagram of a process of detecting missing persons with a vehicle.

FIG. 4 is a flow diagram of a process of detecting missing persons with a vehicle.

FIG. 5 illustrates an example of the detecting system on a vehicle, according to an embodiment of the present disclosure.

FIG. 6 illustrates a camera from the detecting system.

FIG. 7 illustrates the external sensors in the detecting system.

FIG. 8 illustrates an example of a detecting system scanning a multitude of individuals to find a missing person.

FIG. 9 illustrates an example of a detecting system finding a missing person and transmitting a report.

FIG. 10 illustrates an example of a detecting system determining an air quality of an area.

FIGS. 11A and 11B illustrate examples of detecting systems surveilling a disaster-stricken area.

FIGS. 12A, 12B, and 12C illustrate examples of detecting systems analyzing traffic conditions.

FIG. 13 is a schematic illustrating the computing components that may be used to implement various features of embodiments described in the present disclosure.

### DETAILED DESCRIPTION

A detecting system is disclosed, the purpose of which, is to detect a missing person. A missing person may be a lost child, adult, criminal, or a person of interest. The detecting system comprises one or more sensors, one or more cameras, an antenna, and a vehicle that may be driven in an autonomous mode. The one or more sensors and cameras are placed on a top, a bottom, sides, and/or a front and back of the autonomous vehicle. The one or more sensors and cameras scan surroundings of the autonomous vehicle as it drives around. In order to protect privacy of individuals being scanned, an authorization signal may be sent from a third party, such as a police station, and received by the antenna. A driver may consent by pressing a consent button on a user interface associated with the autonomous vehicle and activate the detecting system, otherwise the detecting system will not activate.

If the driver chooses to consent to the authorization signal and activate the detecting system, the detecting system will scan the surroundings of the autonomous vehicle as the autonomous vehicle drives. The detecting system may receive an image of a missing person via an antenna. The one or more cameras may scan individuals walking or driving near the autonomous vehicle. The detecting system compares images of scanned individuals to the image of the missing person. The cameras may use facial recognition techniques to analyze facial features of the scanned individuals. In order to further protect privacy of scanned individuals who do not match the missing person, the detecting system may immediately delete images corresponding to scanned individuals who are not the missing person.

If the detecting system matches an image of a scanned individual to the image of the missing person, then the detecting system will produce a report. The report will contain the image of the scanned individual, a written description, and a location associated with the scanned individual. The detecting system may then send the report back to the third party.

Since the detecting system may constantly scan its surroundings, the detecting system may further protect privacy of scanned individuals who are not the missing person. Upon receiving the authorization signal and the driver consents to it, the detecting system will start a timer which allows the detecting system to work for a limited period of time. This feature prevents the detecting system from scanning individuals indefinitely after the detecting system is activated.

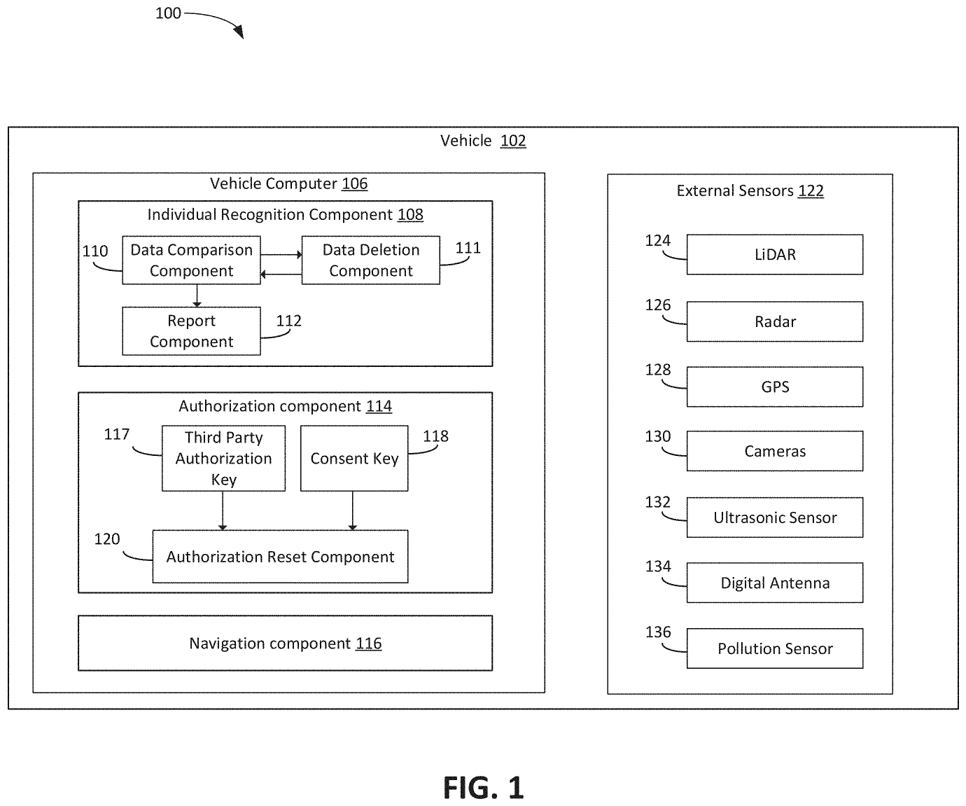

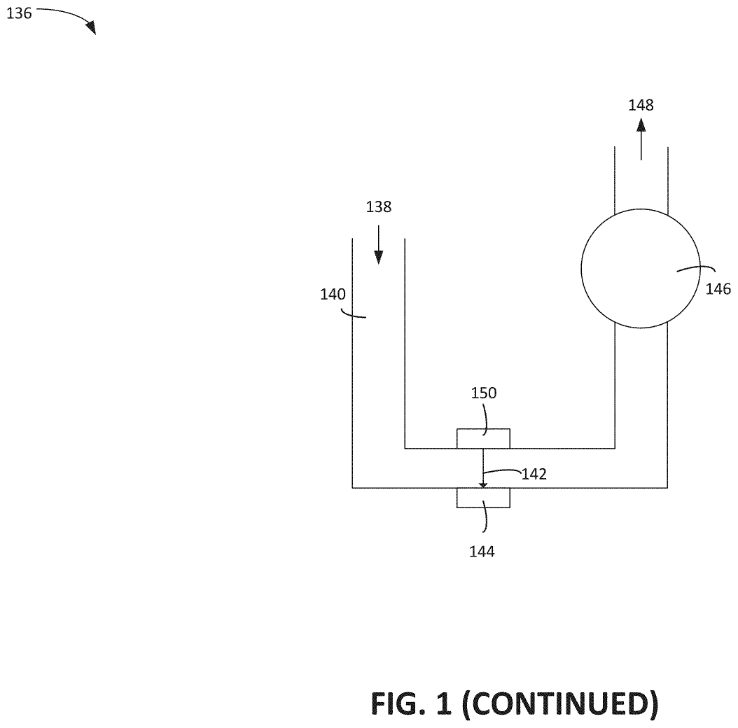

Referring to FIG. 1, FIG. 1 is a schematic illustrating the components that may be used in a detecting system 100. The detecting system 100 leverages a mobility of a vehicle 102 to search for missing persons. The vehicle 102 may be any vehicle that can navigate manually or autonomously from one location to another location. Possible examples of the vehicle 102 are cars, trucks, buses, motorcycles, scooters, hover boards, and trains. The vehicle 102 scans an environment outside the vehicle 102 for individuals as the vehicle 102 drives in a manual or autonomous mode. Individuals that match a description of a missing person are reported by the vehicle 102. The vehicle 102 includes a vehicle computer 106 and external sensors 122.

The vehicle computer 106 may be any computer with a processor, memory, and storage, that is capable of receiving data from the vehicle 102 and sending instructions to the vehicle 102. The vehicle computer 106 may be a single computer system, may be co-located, or located on a cloud-based computer system. The vehicle computer 106 may be placed within the vehicle 102 or may be in a separate location from the vehicle 102. In some embodiments, more than one vehicle 102 share the vehicle computer 106. The vehicle computer 106 matches scanned individuals to missing person descriptions, creates reports, and in some embodiments, operates navigation of the vehicle 102. The vehicle computer 106 includes an individual recognition component 108, an authorization component 114, and a navigation component 116.

The vehicle computer 106 receives data from the external sensors 122 to determine if a scanned individual is a missing person. In one embodiment, the vehicle computer 106 compares images of scanned individuals to an image of the missing person. The vehicle computer 106 determines, based on a comparison if an image of a scanned individual is the missing person.

The vehicle computer 106 may also limit the detecting system 100 from being used as a surveillance tool. The vehicle computer 106 may keep the detecting system 100 in an “off” state until the vehicle computer 106 receives an authorization signal. The authorization signal may be a communication received by a digital antenna 134 of the external sensors 122. In one embodiment, the vehicle computer 106 activates the detecting system 100 in response to receiving an authorization signal.

In some cases, the vehicle computer 106 may permit certain surveillance. For example, the vehicle computer 106 may configure the detecting system 100 for limited surveillance purposes. Such surveillance purposes can include, for example, traffic surveillance, natural condition surveillance, environmental surveillance such as monitoring of smog or air quality, or security surveillance. The vehicle computer 106 may keep the detecting system 100 in an “off” state until the vehicle computer 106 receives an authorization signal authorizing the detecting system 100 for a particular surveillance purpose. In one example, the vehicle computer 106 activates the detecting system 100 for natural condition surveillance of a region after a hurricane or typhoon hit the region in response to receiving an authorization signal authorizing such surveillance. In another example, the vehicle computer 106 activates the detecting system 100 for security surveillance of a region in response to receiving an authorization signal authorizing such surveillance.

In various embodiments, a consent signal must be received by the vehicle computer 106 in addition to an authorization signal, before activating the detecting system 100. The consent signal may be initiated by a user in control of the vehicle 102. In one example, the consent signal is initiated by a button press by a passenger in the vehicle 102. In another example, the consent signal is initiated remotely by a user in control of the vehicle 102 while the vehicle 102 is in an autonomous mode. In various embodiments, the vehicle computer 106 may further limit the detecting system 100 by effectuating a time limit, by which the detecting system 100 switches into an “off” state a period of time after the detecting system 100 is activated.

The individual recognition component 108 determines if a scanned individual is one or more missing individuals. The individual recognition component 108 may be a computer with a processor, memory, and storage. The individual recognition component 108 may share a processor, memory, and storage with the vehicle computer 106 or may comprise a separate computing system. Examples of a missing person may include a criminal, a missing adult or child, or a person of interest. The individual recognition component 108 includes a data comparison component 110, a data deletion component 111, and a report component 112.

The data comparison component 110 compares data from the external sensors 122 data to a missing person description, which may be received by the digital antenna 134. The missing person description is a set of data that describes features of the one or more missing persons. In one example, the missing person description is images of the one or more missing persons. The data comparison component 110 may compare the images of the one or more missing persons to an image of a scanned individual to determine if the images are of the same individual.

In one embodiment, the data comparison component 110 implements a facial recognition technique to determine if an individual, that was scanned by the external sensors 122, matches data that describes the one or more missing persons. In an implementation of the facial recognition technique, an algorithm compares various facial features of an image of a scanned individual to data that describes facial features of the one or more missing persons. The various facial features are measurements of facial elements. Examples of the facial elements may be a distance between eyes, a curvature of a chin, a distance between a nose and cheekbones, a shape of cheekbones, and a shape of eye sockets.

In an exemplary embodiment, the data comparison component 110 uses skin texture analysis to determine if an individual, that was scanned by the external sensors 122, matches data that describes the one or more missing persons. Image data of the missing person is analyzed to discern details of skin such as patterns, lines, or spots. Similarly, details of skin are discerned for scanned individuals. The details of the skin for scanned individuals are compared against the details of the skin for the one or more missing persons.

In various embodiments, the data comparison component 110 compares body features of scanned individuals to data that describes body features of the one or more missing persons. The body features include, but are not limited to: type of clothing, color of clothing, height, width, silhouette, hair style, hair color, body hair, and tattoos. The body features may be compared in combination with other features such as facial features and skin details to determine that a scanned individual matches one or more missing persons.

In various embodiments, data that describes one or more missing persons is broad and results in multiple positive comparisons by the data comparison component 110. Finding multiple individuals that match a description for a missing person effectively narrows a search for the missing person. An overly broad data description of one or more missing persons may be used when more detailed data is not available. For example, the data comparison component 110 may determine if scanned individuals fit a data description of an individual 4 feet tall, with brown hair, white skin, and wearing a red jacket, blue pants, and white shoes. The data comparison component 110 may find multiple individuals that match such a broad description.

The data comparison component 110 is not limited to the embodiments described herein. Various embodiments, not described, may be implemented to compare and determine if scanned individuals match data for one or more missing persons. Recognition systems, not described, such as voice recognition may nonetheless be implemented by the individual recognition component 108 to find missing persons.

A potential negative use of the detecting system 100 is that data collected by the external sensors 122 may be leveraged to track all individuals that are scanned by the external sensors 122. To prevent these detrimental effects of widespread surveillance by using the detecting system 100, the data deletion component 111 may mark data of scanned individuals for deletion if the scanned data does not match data of one or more missing persons and/or redact certain sensitive data. In one embodiment, the data deletion component 111 deletes all scanned data immediately when the data comparison component 110 determines that the scanned data does not match the data of one or more missing persons. In various embodiments, the data comparison component 110 may not compare sensor data to the data of the one or more missing persons until previous sensor data is deleted. The data deletion component 111 authorizes the data comparison component 110 to analyze a first sensor data. The data deletion component 111 authorizes the data comparison component 110 to analyze a second sensor data after the data deletion component 111 deletes the first sensor data. In one implementation, data of scanned individuals that match the data of the one or more missing persons is also deleted after a report is created that specifies locations associated with the scanned individuals. In various embodiments, the data deletion component 111 redacts image data of the scanned individuals by blacking out faces or redacting facial features of the scanned individuals. In various embodiments, the data deletion component 111 may redact the faces of the scanned individuals who are not the one or more missing persons by blurring or pixilation.

The report component 112 generates a report in response to a positive identification by the data comparison component 110. The report may include various data that establishes a location associated with a scanned individual who has been identified as a missing person. In one embodiment, an image of the scanned individual, location associated with the scanned individual, and a general description of the scanned individual (e.g. the color of clothes the scanned individual is wearing.) are included in the report. A GPS 128 sensor may establish the location of the scanned individual for the report component 112. A direction that the scanned individual is travelling may be included in the report. The report component 112 may generate a predictive area of a probable future location of the scanned individual based on the location, the direction of travel, and a speed at which the scanned individual is travelling. The generated report may be broadcast to a third party by the digital antenna 134.

The authorization component 114 limits use of the detecting system 100. The purpose of the authorization component 114 is to prevent abuse or misuse of the detecting system 100. Abuse or misuse of the detecting system 100 may occur if the detecting system 100 is used to track individuals rather than used as a tool to find a genuinely missing person. Abuse or misuse may occur when the detecting system 100 is used to enforce petty laws or used to track down individuals that do not want to be contacted. To prevent possible abuse or misuse of the detecting system 100, the authorization component 114 limits use of the detecting system 100 to the most essential situations and scenarios.

For example, use of the detecting system 100 may be limited by the authorization component 114 by preventing the detecting system 100 from activating unless an authorization signal is received by the vehicle 102. The authorization signal may be received from a third party by the digital antenna 134. The third party is an entity that authorizes a search for one or more missing persons. The authorization signal may include data describing the one or more missing persons. The authorization component 114 may allow the detecting system 100 to operate after receiving the authorization signal.

In one embodiment, the authorization component 114 has a third party authorization key 117. The third party authorization key may be an encrypted key that is paired to an encrypted key held by a third party. The authorization signal will be accepted by the authorization component 114 if the authorization signal contains a proper encryption key that is paired to the third party authorization key 117. Once the authorization signal is accepted by the authorization component 114, the authorization component 114 may activate the detecting system 100. In an exemplary embodiment, the authorization component 114 further limits the detecting system 100 by requiring a consent signal after an authorization signal is received to activate the detecting system 100. The consent signal, like the authorization signal, may be an encrypted key that is paired to an encrypted key held by a user. Unlike the authorization signal, which is received from a third party, the consent signal is received from a user inside the vehicle 102 or a user in control of the vehicle 102. The consent signal is accepted by the authorization component 114 if the consent signal contains a proper encryption key that is paired to the consent key 118. The consent signal may be activated by a button inside the vehicle 102 or through a user interface associated with the vehicle 102. Alternatively, the consent signal may be activated by a mobile device that communicates wirelessly with the vehicle 102. By requiring two signals, an authorization signal paired to a third party authorization key 117 and a consent signal paired to a consent key 118, from two separate entities, ability to abuse or misuse the detecting system 100 is diminished.

In one embodiment, activation of the detecting system 100 may be limited to a period of time by the authorization reset component 120. The period of time limit on the activation of the detecting system 100 prevents the detecting system 100 from remaining in an active state indefinitely after the detecting system is activated. The time limit may be of various durations. The period of time may be set by multiple sources such as the authorization signal, the consent signal, and by a vehicle computer setting. The authorization signal may specify a time limit that the detecting system 100 may operate. Alternatively, a user may specify a time limit as a condition for activating the consent signal. Alternatively, the vehicle computer 106 may have a setting for the maximum period of time that the detecting system 100 may remain active. In one embodiment, if multiple time limits are received by the vehicle 102, such as different time limits from the authorization signal and consent signal, the shortest time limit is the effective time limit.

The navigation component 116 interprets data from the external sensors 122 to operate the vehicle 102 and navigate from one location to another location while the vehicle 102 is in an autonomous mode. The navigation component 116 may be a computer with a processor, memory, and storage. The navigation component 116 may share a processor, memory, and storage with the vehicle computer 106 or may comprise a separate computing system. The navigation component 116 determines location, observes road conditions, finds obstacles, reads signage, determines relative positioning to other individuals or moving objects, and interprets any other relevant events occurring external to the vehicle 102.

The detecting system 100, which scans surroundings of the vehicle 102 for one or more missing persons as the vehicle 102 is navigated, may passively operate without control as to where the vehicle 102 navigates. However, in one embodiment, the vehicle 102 may be instructed to actively navigate to and search specific locations. The navigation component 116 may receive an instruction to navigate to a location. After receiving the instruction, the navigation component may determine a route to the location and generate navigation instructions that, when executed, navigate the vehicle 102 to the location. Alternatively, the navigation component 116 may receive an instruction to patrol an area. The navigation component 116 may then create a route that periodically navigates across the area to patrol the area.

The external sensors 122 collect data from the environment outside the vehicle 102. When the detecting system 100 is in an active state, the external sensors 122 continually scan the environment outside the vehicle 102 for the one or more missing persons. Data collected from external sensors 122 can be interpreted by the individual recognition component 108 to detect and identify missing persons or perform other surveillance functions such as monitoring air pollution. In addition to scanning for missing persons or air pollution, the external sensors 122 provide environmental data for the navigation component 116 to navigate the vehicle 102. In the exemplary embodiments, external sensors 122 include a LiDAR 124, a radar 126, a GPS 128, cameras 130, ultrasonic (proximity) sensors 132, the digital antenna 134, and a pollution sensor 136.

The LiDAR 124 sensor on the vehicle 102 comprises an emitter capable of emitting pulses of light and a receiver capable of receiving the pulses of light. In an exemplary embodiment, the LiDAR 124 emits light in the infrared range. The LiDAR 124 measures distances to objects by emitting a pulse of light and measuring the time that it takes to reflect back to the receiver. The LiDAR 124 can rapidly scan the environment outside the vehicle to generate a 3d map of the surroundings of the vehicle 102. The shapes in the 3d map may be used to detect and identify the location of the missing person. A 3d image of individuals outside the vehicle 102 may be generated based on LiDAR signals.

The radar 126 sensor, like the LiDAR 124, comprises an emitter and receiver. The radar 126 sensor emitter is capable of emitting longer wavelengths of light than LiDAR 124 that are typically in the radio wave spectrum. In an exemplary embodiment, the radar 126 sensor emits a pulse of light at 3 mm wavelength. The longer wavelength light from radar 126 will go through some objects that LiDAR 124 pulses would reflect. Thus, radar signals may detect individuals that are hidden from the view of other external sensors 122.

The vehicle global positioning system (“GPS”) 128 receives a satellite signal from GPS satellites and can interpret the satellite signal to determine the position of the vehicle 102. The GPS 128 continually updates the vehicle 102 position. The position of an individual, who is flagged by the individual recognition component 108, may be determined by the GPS 128 position of the vehicle 102 and the relative distance of the individual from the vehicle 102. The navigation component 116 may use GPS 128 data to aid in operating the vehicle 102.

The cameras 130 can capture image data from the outside of the vehicle 102. Image data may be processed by the individual recognition component 108 to detect and flag individuals that match a description of one or more missing persons. In various embodiments, image taken by the cameras 130 may be analyzed by facial recognition algorithms to identify the missing person. Additionally, the cameras 130 can capture image data and send it to the navigation component 116. The navigation component 116 can process the image data of objects and other environmental features around the vehicle 102. In an exemplary embodiment, images from the cameras 130 are used to identify a location of a scanned individual determined to be a missing person.

Data from the ultrasonic sensors 132 may be used to detect a presence of individuals in an environment outside the vehicle 102. The ultrasonic sensors 132 detect objects by emitting sound pulses and measuring the time to receive those pulses. The ultrasonic sensors 132 can often detect very close objects more reliably than the LiDAR 124, the radar 126 or the cameras 130.

The digital antennas 134 collect data from cell towers, wireless routers, and Bluetooth devices. The digital antennas 134 may receive data transmissions from third parties regarding one or more missing persons. The digital antennas 134 may also receive the authorization signal and consent signal. The digital antennas 134 may receive instructions that may be followed by the navigation component 116 to navigate the vehicle 102. Outside computer systems may transmit data about outside environment. Such data may be collected by the digital antennas 134 to aid in identification of missing persons. In one embodiment, the digital antennas 134 may locate missing individuals by receiving electronic signals from the missing individuals. Individuals may, knowingly or unknowingly, broadcast their locations with electronic devices. These broadcasted locations may be received by the digital antennas 134.

In an exemplary embodiment, a digital antenna 134 collects data transmitted from a cell tower to aid in determining a location of a missing person without the GPS 128. The digital antenna 134 may receive an authorization signal from a third party. The digital antenna may also receive a consent signal if the consent signal is generated by a mobile device. The digital antenna 134 may send a generated report from the individual recognition component 108 to a third party.

The pollution sensor 136 determines a concentration of particulates in air as the vehicle 102 operates. In an exemplary embodiment, the pollution sensor 136 includes a light-emitting photodiode paired to a photodetector across a tube or a tunnel. As the vehicle 102 operates, air is fed into the tube or the tunnel. A concentration of particulates in air can be determined based on an amount of light emitted by the photodiode scattered by the particulates as seen by the photodetector. An amount of light scattered by particulates can be correlated to a concentration of particulates in air. In an exemplary embodiment of the pollution sensor 136, particulates in air may travel into an entrance 138 of the pollution sensor 138, through a channel 140 and pass through a laser beam 142 emitted by a photodiode 150. The laser beam 142 can be scattered depending on a concentration of the particulates. An amount and/or pattern of the laser beam 142 scattering may be detected by a photodetector 144. The photodetector 144 may correlate the amount of the laser beam 142 scattering to a concentration of particulates. The air leaves the pollution sensor 136 through an exit 148. The pollution sensor may further include a fan 146 to avoid an accumulation of dust. A speed of the fan 146 may be dynamically adjusted based on a speed of the airflow through the channel 140 and/or the concentration of particulates, for example, in a feedback loop. The pollution sensor 136 may detect different particulates having different mass densities.

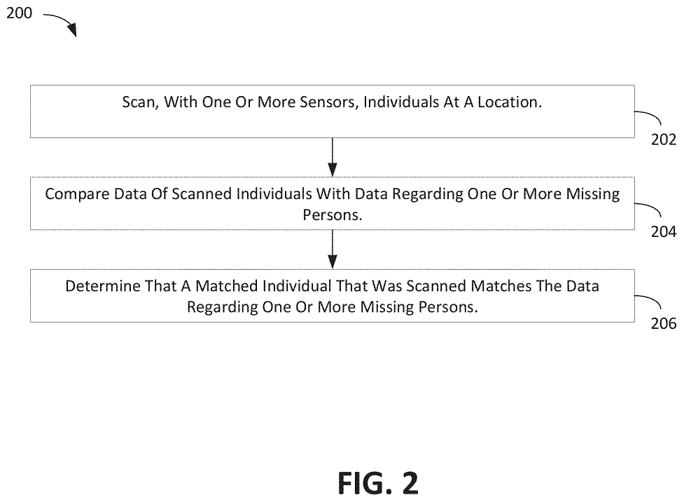

Referring to FIG. 2, FIG. 2 is a flow diagram 200 of a process of detecting missing persons with a vehicle 102. The process of detecting missing persons with a vehicle 102 may be performed with various types of vehicles 102 such as automobiles, motorcycles, scooters, drones, hoverboards, and trains. The process may be performed passively as the vehicle 102 is used to perform a different primary task such as transporting a passenger to a location. Alternatively, the vehicle 102 may perform the process actively for the primary purpose of finding one or more missing persons.

At step 202, the vehicle 102 may scan, with one or more sensors, individuals at a location. The vehicle 102 may be moving or stationary when the vehicle 102 scans individuals at the location. The one or more sensors may be located inside or outside of the vehicle 102. The one or more sensors may be any type of sensor that can detect an individual.

At step 204, the vehicle 102 may compare data of scanned individuals with data regarding one or more missing persons. The data comparison component 110 of the vehicle 102 determines if a scanned individual matches data regarding one or more missing persons. The data regarding one or more missing persons is a description of the missing persons that may be used by the data comparison component 110 to determine if the scanned individuals match the description. In one embodiment, the data regarding one or more missing persons is data that describes features of the one or more missing persons. The data comparison component 110 may use a facial recognition algorithm to compare features extracted from an image of a scanned individual to the data regarding one or more missing persons.

At step 206, the vehicle 102 may determine that the matched individual, matches the data regarding one or more missing persons. In one embodiment, the data comparison component 110 determines that features extracted from images of scanned individuals are a positive match to the data regarding one or more missing persons. The data comparison component 110 may record the flag the scanned individual in response to a positive match. The vehicle 102 may transmit the location of flagged individuals to a third party.

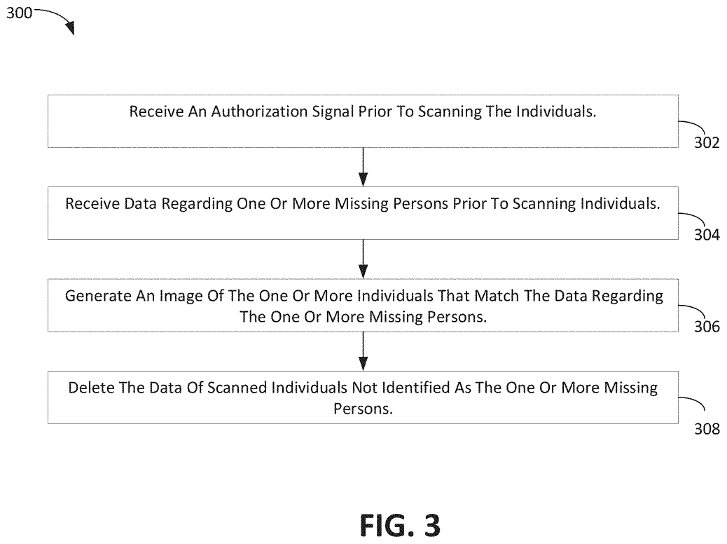

Referring to FIG. 3, FIG. 3 is a flow diagram 300 of a process of detecting missing persons with a vehicle 102. The diagram includes receiving an authorization signal, generating an image of the missing person, and deleting data of scanned individuals that do not match the description of the one or more missing persons. At step 302, the vehicle 102 may receive an authorization signal prior to scanning the individuals. In one embodiment, the vehicle computer 106 may have an encryption key, such that the authorization signal may only be received if the authorization signal contains the correct encryption key pair to the encryption key of the vehicle computer 106. The authorization signal may be sent by various entities that authorize searches for missing persons. Examples of entities that may transmit an authorization signal include, but are not limited to: government organizations, charities, businesses, private organizations, private individuals, and vehicle 102 owners.

At step 304, the vehicle 102 may receive data regarding one or more missing persons prior to scanning individuals. The data may be received at any time, either before or after the authorization signal is received. In one embodiment, the data is received concurrently with the authorization signal. In various embodiments, the data is received separately from the authorization signal. Scans of individuals are compared to the data to determine if the scanned individuals match the data. Various types of scans may be employed to match the scanned individuals to the data. In one embodiment, measurements of camera 130 images of individuals outside vehicle are compared to the data to determine if the individuals match the data. Any number of scanned individuals may match the data. In one example, the data describes a broad set of features that potentially matches a large number of individuals. The broad data description may be implemented when a more detailed description of the one or more missing persons is not available.

At step 306, the vehicle 102 may generate an image of the one or more individuals that match the data regarding the one or more missing persons. The purpose of the image is to allow the quick identification of the one or more missing individuals. The image of the one or more missing persons may convey information not contained in the data such as clothing, hair, and general appearance. The image of the one or more individuals may be generated based on scans taken by the cameras 130 on the vehicle 102. The image may be enhanced by combining multiple scans of the one or more individuals. In one embodiment, the generated image is transmitted, by the digital antenna 134, to a third party. In one embodiment, the vehicle computer 106 may generate a composite image of the scanned individual based on the scans. A composite image may be valuable if the scans, by themselves, do not yield a clear image of the individual. An example of how a composite image can be useful is where the individual recognition component 108 requires multiple scans to match an individual to the data regarding one or more missing persons. In some cases, single scans cannot be used to match the individual. Images, based on those single scans, may therefore not be clear enough to identify the individual later. A clearer composite image can be generated based on the multiple scans.

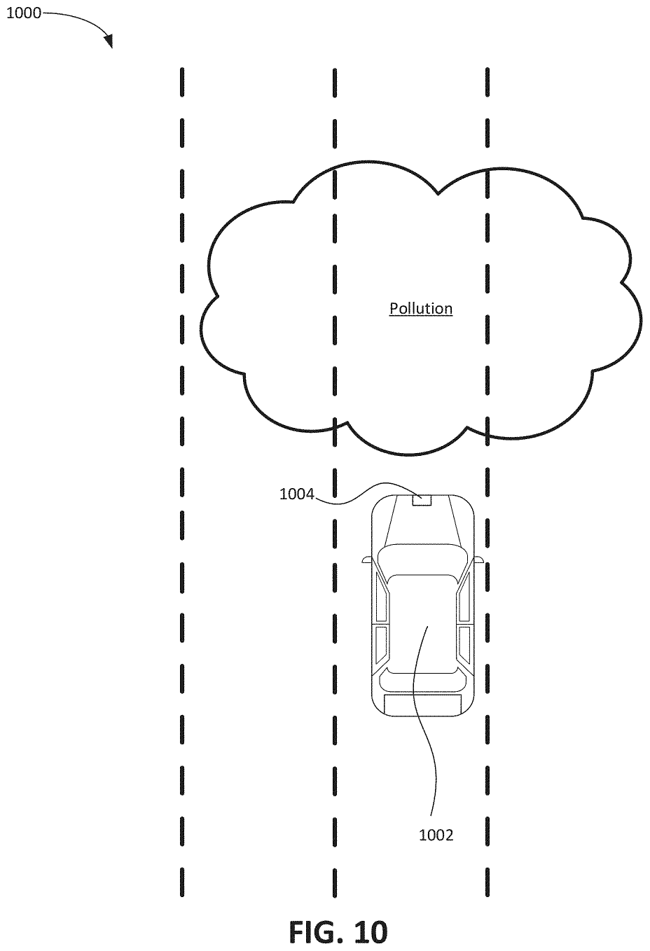

At step 308, the vehicle 102 may delete data of scanned individuals not identified as the one or more missing persons. Deleting scanned data prevents the detecting 100 system from use as a general surveillance tool. In one embodiment, data files of scanned individuals are constantly overwritten in a storage location. The overwriting of a file lowers the probability of the file being recovered at a later date. In various embodiments, data of scanned individuals is never transferred from a main memory 1006 (see FIG. 10) to a ROM 1008 or a storage 1010. The data of scanned individuals is lost when the vehicle computer 106 is turned off.

Also, in various embodiments, all data collected from the external sensors 122 is constantly deleted, including the scans of individuals that match the data regarding one or more missing persons. The data from scans of matching individuals are deleted after information regarding the matching one or more individuals is transmitted by the digital antenna 134. In one embodiment, the information regarding the matching one or more individuals is transmitted as an image of the matching one or more individuals. In an exemplary embodiment, transmitted information is limited to a location coordinate of the matching one or more individuals.

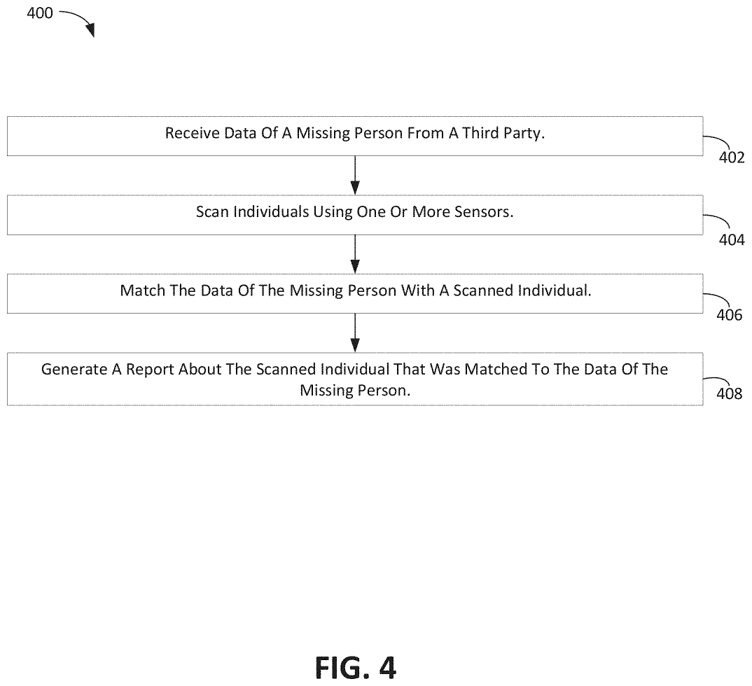

Referring to FIG. 4, FIG. 4 is a flow diagram 400 of a process of detecting missing persons with a vehicle 102. At step 402, the vehicle 102 may receive data of a missing person from a third party. In one embodiment, the data is sent by a wireless signal that is received by the digital antenna 134. The vehicle computer 106 may be located away from the vehicle 102. Therefore, in an exemplary embodiment, the data is received by the vehicle computer 106 via a wired connection. The third party may be various entities. In one example, the third party is an organization that searches for missing people. In various embodiments, an authorization signal must be received before the detecting system 100 is activated. The authorization signal may be received before the data is received, after the data is received, or concurrently as the data is received. The authorization signal may be received from the third party that is searching for the missing person or may be received from a separate authorizing party. The authorizing party may be any entity that can transmit an authorization signal.

The data of a missing person may be various types of data that can be used to match scanned individuals to the data. In one embodiment, the data of the missing person is an image of the missing person. The image of the missing person is matched by the data comparison component 110 to scans of individuals. In various embodiments, the data of the missing person is a set of features. Examples of features that may be included in the data are facial features, body size features, skin features, distinctive mark features, clothing features, and movement features such as a walking style.

At step 404, the vehicle 102 may scan individuals using one or more sensors. The external sensors 122 are used to scan individuals that are in scanning range of the vehicle 102. The vehicle 102 may be moving or stationary as the external sensors 122 scan individuals. The vehicle 102 engine may be on or off as the external sensors 122 scan individuals. The vehicle 102 may scan all individuals within scanning range of the vehicle 102. Alternatively, the vehicle 102 may be instructed to only scan individuals in a specific location. In one embodiment, the vehicle 102 performs preliminary scans to eliminate individuals based on features that can be perceived. The vehicle 102 directs subsequent scans at individuals that could not be eliminated. In exemplary embodiments, the vehicle 102 is instructed to systematically scan an area for a missing person. The navigation component 116 may generate a navigation route that covers the area that the vehicle 102 was instructed to scan. Also, in an exemplary embodiment, the scanning instructions may be incidental to the navigation of the vehicle 102. The vehicle 102 may be instructed to scan any location to which the vehicle 102 incidentally navigates.

At step 406, the vehicle 102 may match the data of the missing person with a scanned individual. The individual recognition component 108 determines, based on scans from the external sensors 122, if the scanned individual matches the data of a missing person. In one embodiment, the individual recognition component 108 implements a facial recognition algorithm to match the scanned individual to the data of the missing person. The individual recognition component 108 may leverage multiple scans from any type of external sensor 122 to determine if a scanned individual matches the data of the missing person. In one example, the facial recognition algorithm compares different features from different scans. The shape of the jaw of the scanned individual may only be measurable in one scan while the distance between the eyes of an individual may only be measurable in another scan.

At step 408, the vehicle may generate a report about the scanned individual that was matched to the data of the missing person. The report component 112 generates the report with any information that may be useful in finding and/or identifying the scanned individual that was matched. The report may include identity of the missing person, the location of the scanned individual, an image from the scanned individual, and a written description of the scanned individual. The written description of the scanned individual may include any identifying features that could be identified by the data comparison component 110. Examples of the features that may be included in the written description are the height of the individual, the color of clothing, belongings, visible tattoos, hair style, and skin color. Images in the report that include individuals other than the missing person may be modified to remove the other individuals. In various embodiments, the detecting system 100 may encrypt the report prior to transmitting it to a third party.

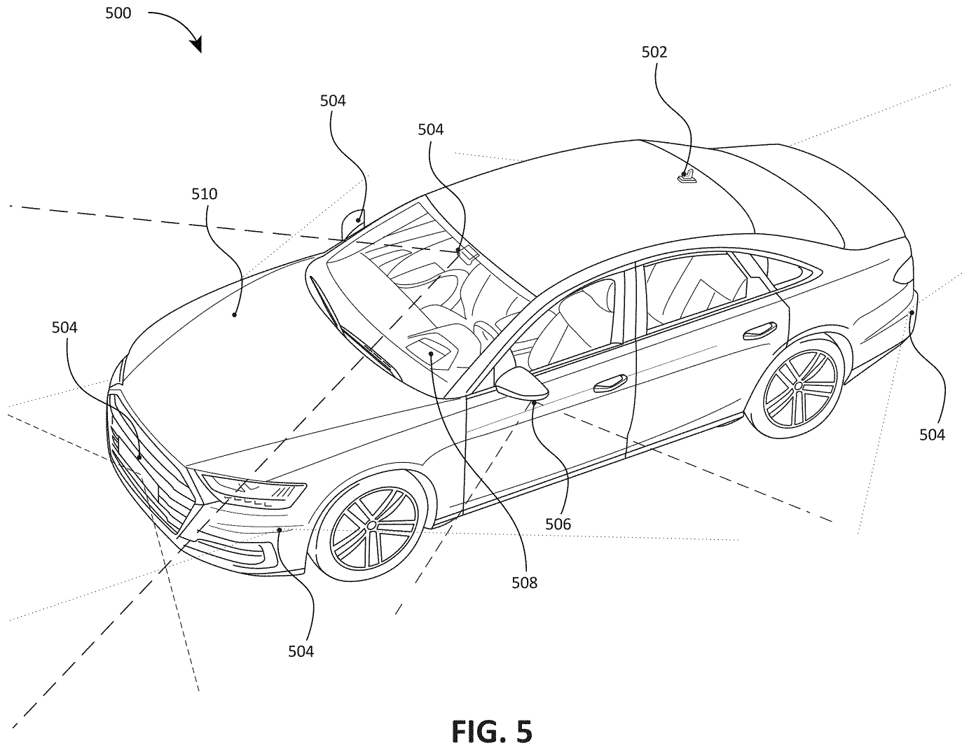

Referring to FIG. 5, FIG. 5 illustrates an example of the detecting system 500 on a vehicle 510, according to an embodiment of the present disclosure. The detecting system 500 on a vehicle 510 is shown in a prospective view. Examples of the vehicle 510 may include any of the following: a sedan, SUV, truck, utility vehicle, police vehicle, or construction vehicle. The detecting system 500 includes an antenna 502, one or more sensors 504, a camera 506, and a vehicle computer 508. The antenna 502 is attached on top of the vehicle 510. The antenna 502 may receive and transmit wireless signals to other vehicles or third parties. In various embodiments, the antenna 502 may receive and/or transmit information over communication standards including but not limited to: wifi, LTE, 4G, 3G, or 5G.

The sensors 504 are located all around the vehicle 510. The sensors 504 may detect a missing person or perform other surveillance functions when the vehicle 510 is driving or stationary. The camera 506 is attached to the vehicle 510. The camera 506 is able to scan individuals by taking images of the individuals. Images of individuals are processed by the vehicle computer 508 to match the individuals to data regarding one or more missing persons. The camera 506 may be attached at various positions around the vehicle 510. In various embodiments, the camera 506 may be placed on the top, sides, bottom, front or back of the vehicle 510.

In one embodiment, also shown in FIG. 5, the vehicle computer 508 is attached to the vehicle 510. The vehicle computer 508 may receive data from the camera 506 and the antenna 502. The vehicle computer 508 may determine if an image taken by the camera 506 contains the missing person. In response to determining that a scanned image contains the missing person, the vehicle computer 508 may generate a report, which contains image data regarding the scanned image. The generated report may be transmitted to a third party by the antenna 502.

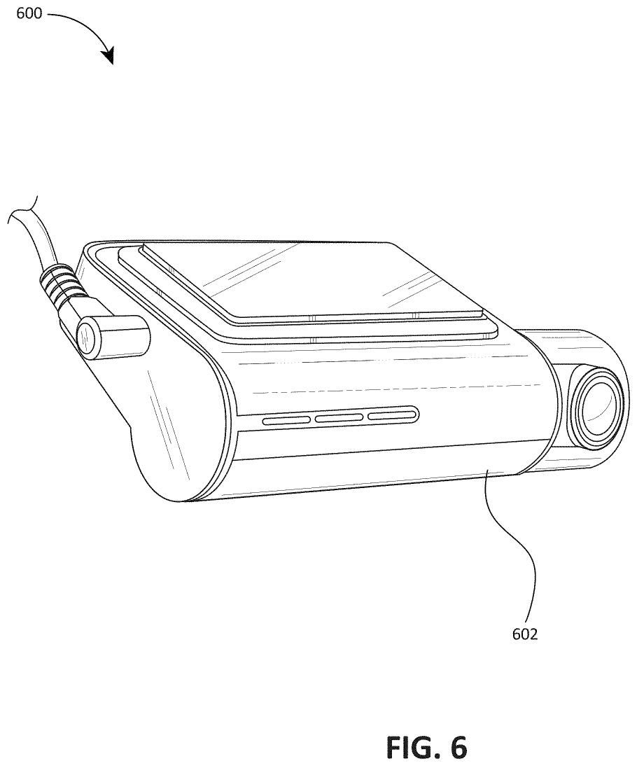

Referring to FIG. 6, FIG. 6 illustrates a camera 602 of the detecting system 600, according to an embodiment of the present disclosure. The detecting system 600 may detect missing persons by using the camera 602 to take images of the missing person. Any number of cameras 602 may be attached and used by the vehicle 510. Multiple cameras 602 may be strategically placed around the vehicle 510 to facilitate scanning the environment around the vehicle 510.

The camera 602 may take images of the surroundings of the vehicle. In various embodiments, different cameras 602 attached to the vehicle 510 may have different lenses. A camera 602 with a lens that has a wide angle of view may scan a preliminary image. The wide angle of view will capture an image that covers a large portion of the environment around the vehicle 102. The preliminary image may be processed by the data comparison component 110. The data comparison component 110 compares features of the individuals in the preliminary image to data regarding one or more missing persons. Individuals in the preliminary image may be eliminated from consideration as possible missing persons if features of the individuals do not match the data regarding one or more missing persons.

A second camera 602 with a larger focal length lens than the wide angle of view camera 602 may scan individuals that could not be eliminated as possible missing persons in the preliminary image. The second camera 602 with a larger focal length may take images that are higher in resolution than the preliminary image. Features of individuals that could not be made out in the low resolution preliminary image may be visible in the higher resolution. The higher resolution images may be processed by the data comparison component 110 to determine if the scanned individuals match the data regarding one or more missing persons.

Individuals that are a positive match to the data regarding one or more missing persons may be scanned one or more additional times by the camera 602 with a higher focal length lens. Images of the additional scans may be transmitted by the digital antenna 134 to a third party. Images of some individuals will not be clear enough to eliminate the individuals as possible matches to the data regarding one or more missing persons. Additional images of those un-eliminated individuals may also be scanned by the camera 602 with a higher focal length lens and transmitted by the digital antenna 134.

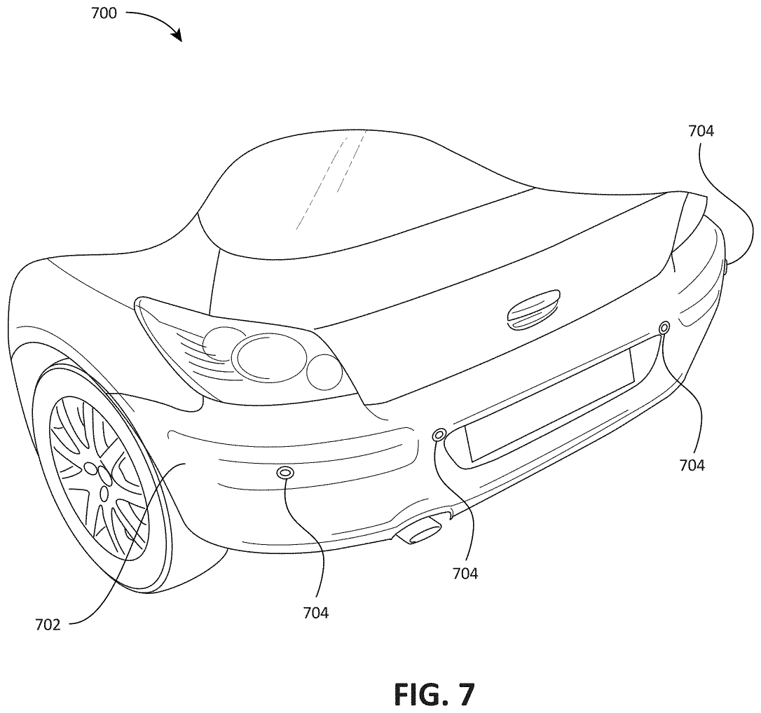

Referring to FIG. 7, FIG. 7 illustrates an example of the detecting system 700 on a vehicle 702, according to an embodiment of the present disclosure. External sensors 704 may be placed around the vehicle 702 to scan as much of the environment around the vehicle 702 as is feasible. When the detecting system 100 is active, scans of the external sensors 704 ideally completely cover the immediate area around the vehicle 702.

The external sensors 704 may be immobile. Immobile sensors scan at a fixed angle relative to the vehicle 702. In one embodiment where the detecting system passively scans the environment, the external sensors 704, which are immobile, may scan all of the environment that incidentally comes within the range of the external sensors 704. The navigation component 116 does not consider the external sensors 704 for navigation of the vehicle 702.

In various embodiments, the navigation component 116 may position the vehicle 702 to more effectively scan individuals. The navigation component 116 may use a preliminary scan by an external sensor 704 to determine the likely location of individuals. Based on the preliminary scan, the navigation component may direct the vehicle 702 to drive to a position that enhances the subsequent scans of one or more external sensors 704. The preliminary and subsequent scans may be taken by the same external sensor 704 or by different external sensors 704. In one example, the preliminary scan is taken by a camera 130 with a wide angle lens. The subsequent scan is taken by a camera 130 with a larger focal length than the camera 130 with a wide angle lens. The subsequent scan may have a higher resolution than the preliminary scan.

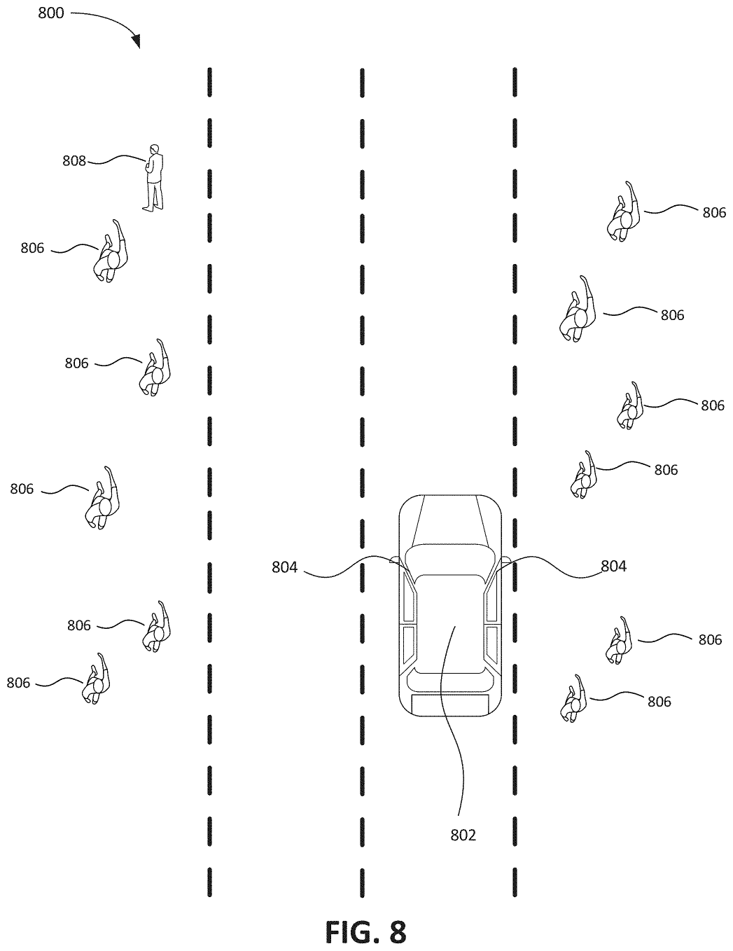

Referring to FIG. 8, FIG. 8 illustrates an example of the detecting system 800, according to an embodiment of the present disclosure. The detecting system 800 may locate a missing person 808 that is among other individuals 806 that are walking or driving near a vehicle 802 as the vehicle 802 is driven. In some cases, the detecting system 800 may perform security surveillance. As shown in FIG. 8, the vehicle 802 includes two cameras 804 at the sides of the vehicle 802 that takes images of individuals that are within camera range of the left and right side of the vehicle 802. Based on these images, the detecting system 800 can identify the missing person 808 or determine suspicious or criminal activities or behaviors.

The cameras 804, which are fixed on the left and right sides of the vehicle 802, may scan substantially all individuals 806 that the vehicle 802 passes on a road if there is an unobstructed view of the individuals 806 from the vehicle 802. The data comparison component 110 determines if the individuals 806 match data regarding a missing person 808. Image files of the individuals 806 that do not match the data regarding the missing person 808 may be immediately deleted.

A scanned image of the missing person may be matched to data regarding the missing person 808 by the data comparison component 110. In response to matching the image of the missing person 808 to the data regarding the missing person, the report component 112 of the vehicle computer 106 may generate a report. The report may contain any information that would aid third parties in locating the missing person 808. In one embodiment, the report contains coordinates describing the location of the missing person 808. In an exemplary embodiment, the report contains an image, of the missing person, that was taken by the camera 804.

In some cases, scanned images of individuals can depict an on-going suspicious or criminal activity. For example, the scanned images depict a person being chased by another person. Based on the scanned images, the vehicle computer 106 may determine that a suspicious or criminal activity is afoot. The vehicle computer 106 may transmit an alert through the digital antenna 134 to a third party that a potential criminal activity may be afoot. The alert includes images relating to the suspicious or criminal activity and a location of the suspicious or criminal activity.

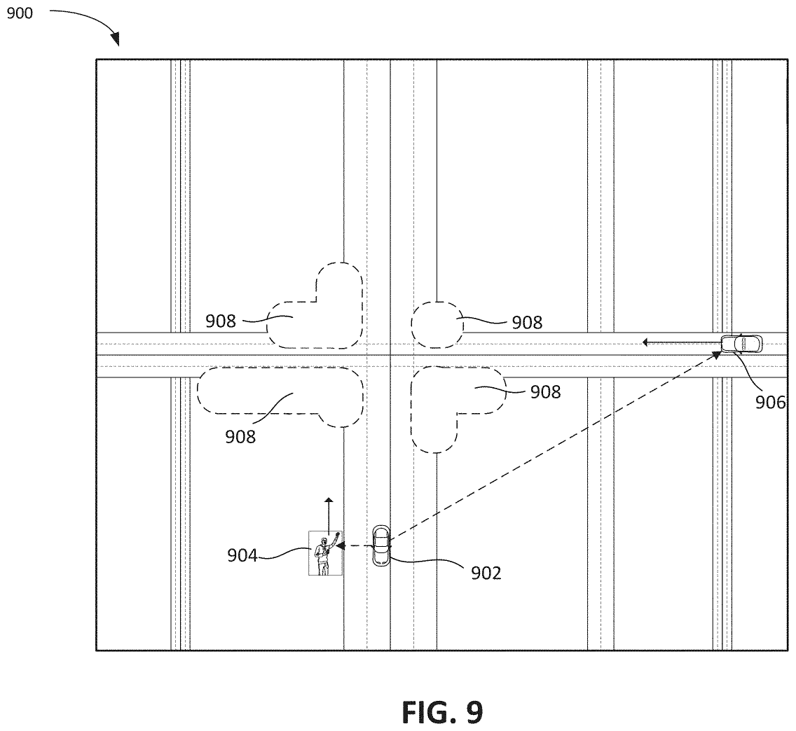

Referring to FIG. 9, FIG. 9 illustrates an example of the detecting system 900, being implemented to find a person and transmit a report. Before activating the detecting system 100 and scanning for one or more missing persons, the vehicle 902 may require an authorization signal. In addition to the authorization signal, the vehicle 902 may also require a consent signal before activating the detecting system 100. Once the detecting system 100 has been activated, the authorization reset component 120 may deactivate the detecting system 100 after a period of time.

Once the detecting system 100 has been activated in the vehicle 902, the external sensors 122 on the vehicle 902 may scan the environment around the vehicle for individuals that match data regarding one or more missing persons. The data comparison component 110 compares external sensor data to the data regarding one or more missing persons to determine if individuals in the environment are the one or more missing persons. In one embodiment, the data deletion component 111 prevents the data comparison component 110 from analyzing a second external sensor data after a first external sensor data has been collected. The first external sensor data and the second external sensor data are arbitrary amounts of sensor data that have been collected and stored in memory. The data deletion component 111 allows the data comparison component 110 to analyze the second external sensor data after the first external sensor data has been deleted. The data deletion component 111 prevents the external sensor 122 data from being used as a general surveillance tool by forcing the deletion of external sensor 122 data.

Once the data comparison component 110 determines that an individual matches the data regarding one or more missing persons, the report component 112 may generate a report of the matched individual 904. The report may include an image of the matched individual 904, a written description of the matched individual 904 and a location of the matched individual 904. The written description may include various details of the matched individual that may aid a third party in locating the matched individual 904. The written description may include, but is not limited to the clothing of the matched individual 904, the direction of travel of the matched individual 904, the speed of the matched individual 904, and a predicted destination 908 of the matched individual 904. The predicted destination 908 of the matched individual 904 is an estimate for the area that the matched individual 904 is likely to be found in after a period of time based on the direction of travel and the speed of the matched individual 904. The report may include an image of the predicted destination 908 on a map. As shown in FIG. 9, the report component 112 determined the predicted destination 908 to be around one of four sides of an intersection.

The generated report may be transmitted to a third party via the digital antenna 134. The third party may be any entity. In one embodiment, shown in FIG. 9, the third party is a police car 906. The police car 906 may receive the generated report and act upon it. As shown in FIG. 9 by the arrow from the police car 906, the police car 906 accelerates toward the predicted destination 908 of the matched individual 904 to attempt to find the matched individual.

Referring to FIG. 10, FIG. 10 illustrates an example of the detecting system 1000, according to an embodiment of the present disclosure. The detection system 1000 may include one or more processors and determine an air quality of an area surrounding a vehicle 1002. As shown in FIG. 10, the vehicle 1002 includes a pollution sensor 1004. The pollution sensor may be implemented as the pollution sensor 136 in FIG. 1, for example. The pollution sensor 1004 can determine air quality based on measuring light scattered by particulates in air. As the vehicle 1002 drives in the area, a portion of outside air is fed into the pollution sensor 1004. Particulates in the portion of outside air scatter light emitted by a photodiode (e.g., a laser light source) as seen by a photodetector. Based on this light scatter, the vehicle computer 106 can determine the air quality of the area.

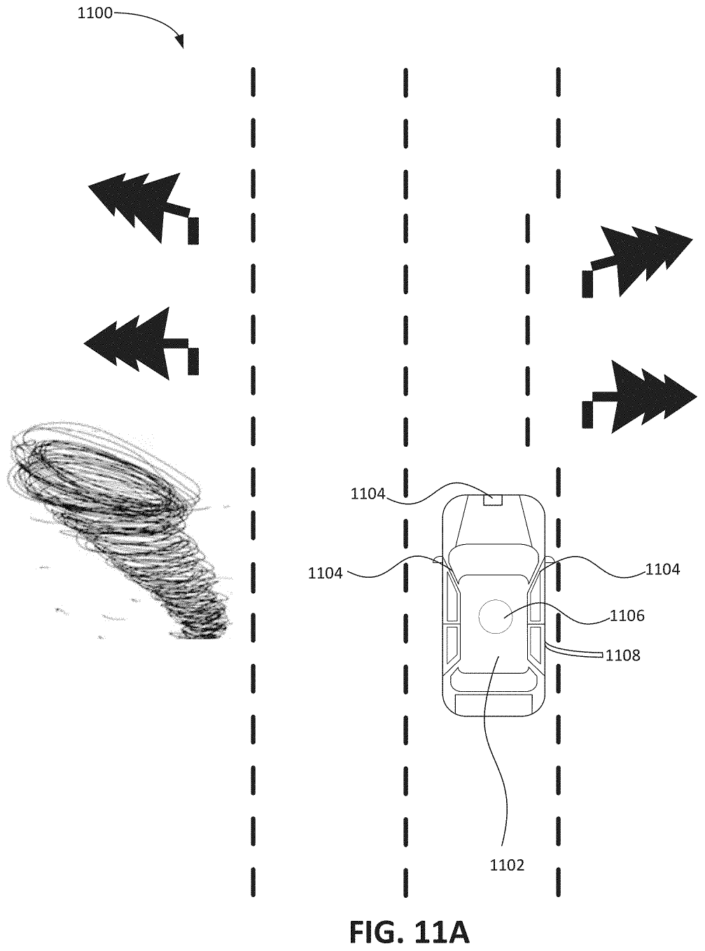

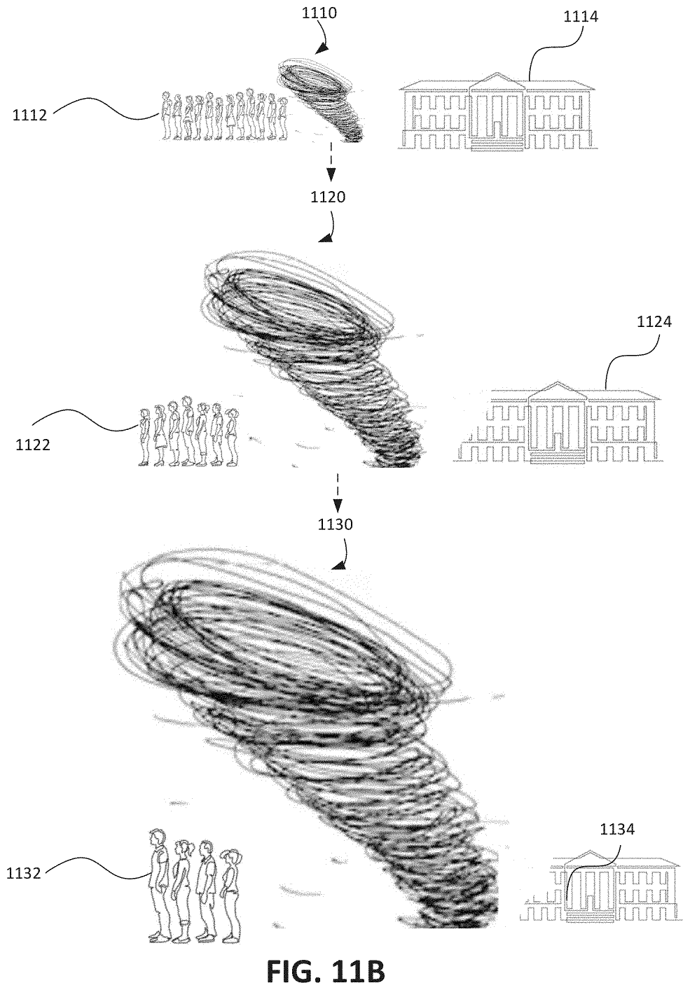

Referring to FIG. 11A, FIG. 11A illustrates an example of the detecting system 1000, according to an embodiment of the present disclosure. The detecting system 1000 may be used to analyze or surveil a disaster-stricken area. As shown in FIG. 11A, the detecting system 1000 may be part of the vehicle 1102. The vehicle 1102 may be an autonomous vehicle. In FIG. 11A, the vehicle 1102 receives an authorization signal from a third party to surveil a disaster-stricken area and a user in control of the vehicle 1102 consents to the authorization signal. In response, the vehicle 1102 drives to the disaster-stricken area and uses cameras 1104 and a LiDAR 1106 to provide live video streams of the disaster-stricken area as the vehicle 1102 operates. In some cases, the vehicle 1102 can relay the live video streams to the third party. In some cases, the detecting system 1000 can, from the live video streams, analyze or determine a type and/or severity of the disaster, for example, by comparing sequential frames of the disaster over time. For example, as shown in FIG. 11B, the vehicle 1102 may acquire sequential video streams 1110, 1120, and 1130. The detecting system 1000 may analyze the sequential video streams 1110, 1120, and 1130 using semantic segmentation and/or instance segmentation to identify particular features of the sequential video streams 1110, 1120, and 1130, such as, people 1112, 1122, and 1132, and/or structures such as buildings 1114, 1124, and 1134. The detecting system 1000 may determine a severity based on a size of a disaster, a change in the size of the disaster over sequential video streams, a concentration of people present around the disaster, a change in the concentration of people present around the disaster, a condition of a structure or building around the disaster, and/or a change in the condition of the structure of building. For example, the detecting system 1000 may determine that the severity of the disaster may be high as a result of the disaster getting larger in scale over the sequential video streams 1110, 1120, and 1130, and/or the building 1114, 1124, and 1134 getting worse in condition or falling apart. The detecting system 1000 may further decrease a predicted severity of the disaster as a result of a concentration of people 1112, 1122, and 1132 decreasing over the sequential video streams 1110, 1120, and 1130. The detecting system 1000 may include a machine learning model that may be trained using training datasets. For example, a first set of training datasets may include factors to analyze or predict a severity of a disaster from a single image. Following training using the first set, a second set of training datasets, which may include factors to analyze or predict a severity of a disaster from changes across a sequence of images or videos, may be used to train the detecting system 1000.

In some embodiments, the vehicle 1102 may, depending on the determined type and/or severity of the disaster, enact measures in an effort to mitigate the disaster. For example, if the type of the disaster is determined to be a fire, the vehicle 1102 may spray water or other flame retardant fluid towards the disaster using, for example, a pressurized hose 1108. While the vehicle 1102 is enacting measures to mitigate the disaster, the vehicle 1102 may continue to acquire video streams so that the detecting system 1000 may determine whether the measures are in fact mitigating the disaster. If the measures are not, or no longer, mitigating the disaster, the vehicle 1102 may terminate its current efforts, for example, stop a flow of water or fluid retardant fluid from the pressurized hose 1108, and/or attempt a different measure to mitigate the disaster.

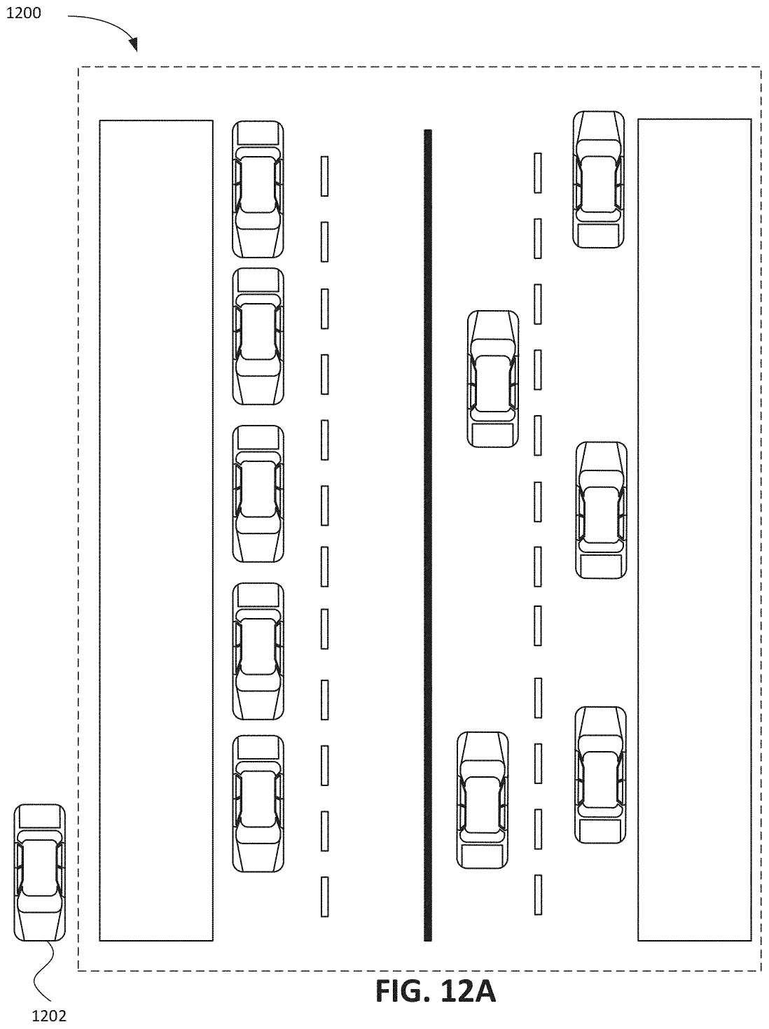

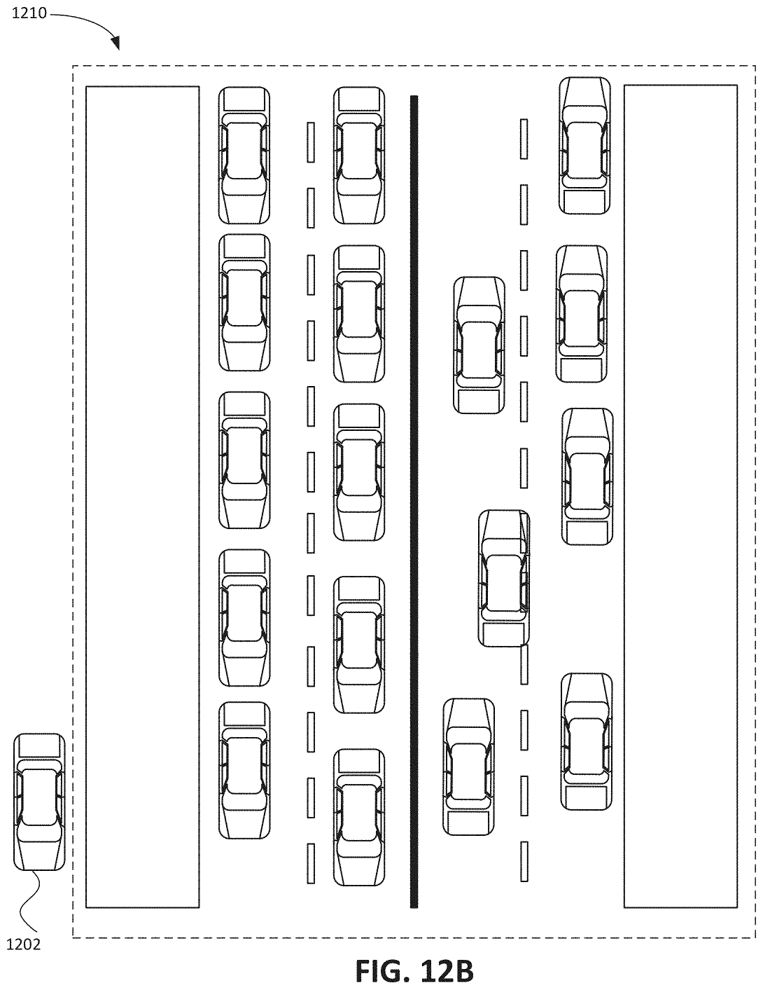

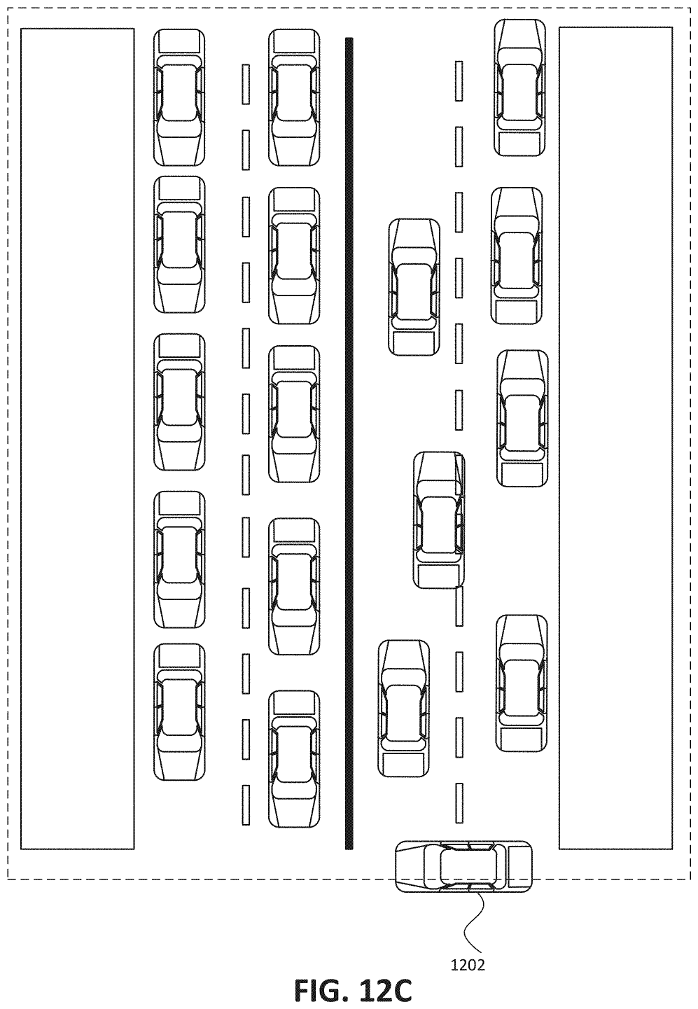

Referring to FIG. 12A and FIG. 12B, FIG. 12A and FIG. 12B illustrates an example of the detecting system 1000, according to an embodiment of the present disclosure. The detecting system 1000 may be used to analyze traffic conditions, such as a traffic density and/or traffic distribution. The detecting system 1000 may also analyze changes in traffic conditions, for example, across image or video frames 1200 and 1210 captured by a vehicle 1202. In some examples, if the detected traffic density, and/or if a rate of increase of the traffic density exceeds a threshold, the detecting system 1000 may determine that a portion of a road should be blockaded to prevent entry from additional traffic, and/or that the additional traffic should be directed or diverted to an alternative road. The vehicle 1202 may blockade a portion of the road and/or direct or divert additional traffic to an alternative road, as shown in FIG. 12C. In some embodiments, the vehicle 1202 may position itself, and/or recruit other vehicles, in order to blockade a portion of a road to prevent additional traffic from entering.

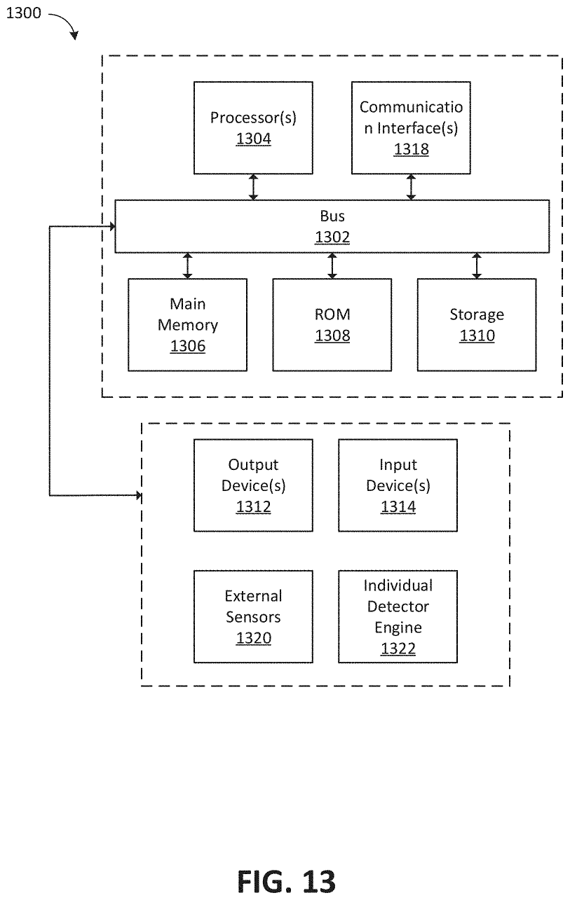

Referring to FIG. 13, FIG. 13 is a block diagram that illustrates a computer system 1300 upon which various embodiments of the vehicle computer 106 may be implemented. The computer system 1300 includes a bus 1302 or other communication mechanism for communicating information, one or more hardware processors 1304 coupled with bus 1302 for processing information. Hardware processor(s) 1304 may be, for example, one or more general purpose microprocessors.

The computer system 1300 also includes a main memory 1306, such as a random access memory (RAM), cache and/or other dynamic storage devices, coupled to bus 1302 for storing information and instructions to be executed by processor 1304. Main memory 1306 also may be used for storing temporary variables or other intermediate information during execution of instructions to be executed by processor 1304. Such instructions, when stored in storage media accessible to processor 1304, render computer system 1300 into a special-purpose machine that is customized to perform the operations specified in the instructions.

The computer system 1300 further includes a read only memory (ROM) 1308 or other static storage device coupled to bus 1302 for storing static information and instructions for processor 1304. A storage device 1310, such as a magnetic disk, optical disk, or USB thumb drive (Flash drive), etc., is provided and coupled to bus 1302 for storing information and instructions. In one embodiment, images of scanned individuals are not stored in ROM 1308 or the storage device 1310 unless the image of the scanned individual matches the image of a missing person. The image of the scanned individual may be deleted by being written over in the main memory 1306.

The computer system 1300 may be coupled via bus 1302 to an output device 1312, such as a cathode ray tube (CRT) or LCD display (or touch screen), for displaying information to a computer user. An input device 1314, including alphanumeric and other keys, is coupled to bus 1302 for communicating information and command selections to processor 1304. The external sensors 1320 of the vehicle may be coupled to the bus to communicate information on the environment outside the vehicle 102. Data from the external sensors 1320 is used directly by the data comparison component 110 to detect and identify missing persons. Another type of user input device is cursor control, such as a mouse, a trackball, or cursor direction keys for communicating direction information and command selections to processor 1304 and for controlling cursor movement on an output device 1312. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computer system 1300 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors 1304. The modules or computing device functionality described herein are preferably implemented as software modules but may be represented in hardware or firmware. Generally, the modules described herein refer to logical modules that may be combined with other modules or divided into sub-modules despite their physical organization or storage.

The computer system 1300 may implement the techniques described herein using customized hard-wired logic, one or more ASICs or FPGAs, firmware and/or program logic which in combination with the computer system 1300 causes or programs the computer system 1300 to be a special-purpose machine. According to one embodiment, the techniques herein are performed by computer system 1300 in response to processor(s) 1304 executing one or more sequences of one or more instructions contained in main memory 1306. Such instructions may be read into main memory 1306 from another storage medium, such as storage device 1010. Execution of the sequences of instructions contained in main memory 1306 causes processor(s) 1304 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1310. Volatile media includes dynamic memory, such as main memory 1306. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid-state drive of a remote computer. The remote computer can load the instructions into its dynamic memory and send the instructions over a telephone line using a component control. A component control local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may retrieve and execute the instructions. The instructions received by main memory 1306 may optionally be stored on storage device 1310 either before or after execution by processor 1304.

The computer system 1300 also includes a communication interface 1318 coupled to bus 1302. Communication interface 1318 provides a two-way data communication coupling to one or more network links that are connected to one or more local networks. For example, communication interface 1318 may be an integrated services digital network (ISDN) card, cable component control, satellite component control, or a component control to provide a data communication connection to a corresponding type of telephone line. As another example, communication interface 1318 may be a local area network (LAN) card to provide a data communication connection to a compatible LAN (or WAN component to communicated with a WAN). Wireless links may also be implemented. In any such implementation, communication interface 1318 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world-wide packet data communication network now commonly referred to as the “Internet.” Local network and Internet both use electrical, electromagnetic or optical signals that carry digital data streams. The signals through the various networks and the signals on network link and through communication interface 1318, which carry the digital data to and from computer system 1300, are example forms of transmission media. The computer system 1300 can send messages and receive data, including program code, through the network(s), network link and communication interface 1318. In the Internet example, a server might transmit a requested code for an application program through the Internet, the ISP, the local network and the communication interface 1318.

The received code may be executed by processor 1304 as it is received, and/or stored in storage device 1310, or other non-volatile storage for later execution. Each of the processes, methods, and algorithms described in the preceding sections may be embodied in, and fully or partially automated by, code modules executed by one or more computer systems 1300 or computer processors 1304 comprising computer hardware. The processes and algorithms may be implemented partially or wholly in application-specific circuitry.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

The various operations of example methods described herein may be performed, at least partially, by one or more processors 1304 that are temporarily configured (e.g., by software) or permanently configured to perform the relevant operations. Similarly, the methods described herein may be at least partially processor-implemented, with a particular processor 1304 or processors 1304 being an example of hardware. For example, at least some of the operations of a method may be performed by one or more processors 1304. Moreover, the one or more processors 1304 may also operate to support performance of the relevant operations in a “cloud computing” environment or as a “software as a service” (SaaS). For example, at least some of the operations may be performed by a group of computers (as examples of machines including processors 1304), with these operations being accessible via a network (e.g., the Internet) and via one or more appropriate interfaces (e.g., an Application Program Interface (API)).

The performance of certain of the operations may be distributed among the processors 1004, not only residing within a single machine, but deployed across a number of machines. In some example embodiments, the processors 1304 may be located in a single geographic location (e.g., within a home environment, an office environment, or a server farm). In other example embodiments, the processors 1304 may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The phrases “at least one of,” “at least one selected from the group of,” or “at least one selected from the group consisting of,” and the like are to be interpreted in the disjunctive (e.g., not to be interpreted as at least one of A and at least one of B).

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A method implemented by one or more processors of detecting and addressing a potential danger, comprising:
acquiring data, using one or more sensors on a vehicle, at a location;
identifying, using the one or more processors, characteristics at the location based on the acquired data;
determining, based on the identified characteristics, a level of danger at the location; and
in response to determining that the level of danger satisfies a threshold level, issuing an alert.

2. The method of claim 1, wherein:
the one or more sensors comprise a particulate sensor; and
the identifying the characteristics comprises determining a particulate concentration, the determining the particulate concentration comprising:
channeling air through a laser beam in a channel of the particulate sensor;
detecting, by a photodetector of the particulate sensor, an amount and pattern of light scattered by the laser beam; and
determining the particulate concentration based on the amount and the pattern of light scattered by the laser beam.

3. The method of claim 1, wherein:
the one or more sensors comprise a LiDAR and a camera; and
the identifying the characteristics comprises determining an existence, a type, and a severity of a disaster.

4. The method of claim 3, wherein the determining the existence, the type, and the severity of the disaster comprises:
acquiring sequential video frames of the disaster;
identifying, using semantic segmentation and instance segmentation, features in the sequential video frames;
detecting changes in the features across the sequential video frames; and
determining the existence, the type, and the severity of the disaster based on the detected changes.

5. The method of claim 4, wherein the determining the existence, the type, and the severity of the disaster is implemented using a trained machine learning model, the training of the machine learning model comprising training using a first set of training data based on an analysis of a single frame and a second set of training data based on an analysis across frames.

6. The method of claim 3, further comprising:
in response to detecting that the type of the disaster is a fire, activating a pressurized hose of the vehicle to spray water or a flame retardant fluid over the disaster.

7. The method of claim 6, further comprising:
acquiring additional video frames of the disaster while spraying the water or the flame retardant fluid over the disaster;
determining, from the additional acquired video frames, whether the disaster is being mitigated;
in response to determining that the disaster is being mitigated, continuing to spray the water or the flame retardant fluid over the disaster; and
in response to determining that the disaster is not being mitigated, terminating the spraying of the water or the flame retardant fluid over the disaster and issuing an alert.

8. The method of claim 4, wherein the detecting the changes in the features comprises detecting changes in a concentration of people and changes in a structure at the location.

9. The method of claim 1, wherein the identifying, with one or more sensors on a vehicle, characteristics at a location, comprises identifying a level of traffic at the location.

10. The method of claim 9, further comprising:
in response to detecting that the level of traffic exceeds a traffic threshold, blockading additional vehicles from entering the location or directing the additional vehicles through an alternative route.

11. A system on a vehicle, comprising:
one or more sensors configured to acquiring data at a location;
one or more processors; and
memory storing instructions that, when executed by the one or more processors, cause the system to:
identify characteristics, based on the acquired data, at the location;
determine, based on the identified characteristics, a level of danger at the location; and
in response to determining that the level of danger satisfies a threshold level, issuing an alert.

12. The system of claim 11, wherein:
the one or more sensors comprise a particulate sensor, the particulate sensor comprising:
a channel through which air is funneled through;
a photodiode configured to emit a laser beam;
a photodetector configured to detect an amount and a pattern of scattering from the laser beam and determine a particulate concentration of the air based on the amount and the pattern of light scattered by the laser beam; and
a fan, wherein a speed of the fan is adjusted based on the determined particulate concentration of the air.

13. The system of claim 11, wherein:
the one or more sensors comprise a LiDAR and a camera; and
the identifying the characteristics comprises determining an existence, a type, and a severity of a disaster.

14. The system of claim 13, wherein the determining the existence, the type, and the severity of the disaster comprises:
acquiring sequential video frames of the disaster;
identifying, using semantic segmentation and instance segmentation, features in the sequential video frames;
detecting changes in the features across the sequential video frames; and
determining the existence, the type, and the severity of the disaster based on the detected changes.

15. The system of claim 14, wherein the determining the existence, the type, and the severity of the disaster is implemented using a trained machine learning model, the training of the machine learning model comprising training using a first set of training data based on an analysis of a single frame and a second set of training data based on an analysis across frames.

16. The system of claim 13, wherein, the instructions further cause the system to perform:
in response to detecting that the type of the disaster is a fire, activating a pressurized hose of the vehicle to spray water or a flame retardant fluid over the disaster.

17. The system of claim 16, wherein, the instructions further cause the system to perform:
acquiring additional video frames of the disaster while spraying the water or the flame retardant fluid over the disaster;
determining, from the additional acquired video frames, whether the disaster is being mitigated;
in response to determining that the disaster is being mitigated, continuing to spray the water or the flame retardant fluid over the disaster; and
in response to determining that the disaster is not being mitigated, terminating the spraying of the water or the flame retardant fluid over the disaster and issuing an alert.

18. The system of claim 14, wherein the detecting the changes in the features comprises detecting changes in a concentration of people and changes in a structure at the location.

19. The system of claim 11, wherein the identifying the characteristics at the location comprises identifying a level of traffic at the location.

20. The system of claim 19, wherein the instructions further cause the system to perform:
in response to detecting that the level of traffic exceeds a traffic threshold, blockading additional vehicles from entering the location or directing the additional vehicles through an alternative route.
